(19) United States
(12) Patent Application Publication
(10) Pub. No.: US 2014/0021218 A1
(43) Pub. Date: Jan. 23, 2014

(54) IMPROVED VENDING MACHINE

(71) Applicant: Gjon Bisha, Osimo (AN) (IT)

(72) Inventor: Gjon Bisha, Osimo (AN) (IT)

(21) Appl. No.: 14/009,460

(22) PCT Filed: May 4, 2012
(86) PCT No.: PCT/IT12/00132

§ 371 Date: Oct. 2, 2013

(51) Int. Cl. G07F 11/42

(52) U.S. Cl. CPC G07F 11/42
USPC 221/258

(57) ABSTRACT

A vending machine has a set of shelves for products to be dispensed, which are moved by a transportation means comprising dividers with variable distance in such manner to exactly contain products of various size.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present patent application for industrial invention relates to an improved vending machine.

2. Description of Related Art Including Information Disclosed Under 37 CFR 1.97 and 37 CFR 1.98

As it is known, vending machines are largely used to dispense products, such as soft drinks, cigarettes and packaged products in general.

However, the current operation and management modes of said vending machines are impaired by some considerable drawbacks.

The major drawback refers to vending machines that are designed to contain different products.

Said vending machines are provided with a series of shelves on which different products are supported, being sorted by type.

Specifically, identical products are arranged in a line and the first product, i.e. the one in the proximity of the front edge of the shelf, is designed to be dispensed further to a simultaneous forward movement of all products in the same line.

More precisely, said vending machines are provided with handling systems for the product lines, which push the entire line forward (towards the front edge of the shelf) so that the first product goes beyond said front edge and falls into a discharge chute.

In order to use at best the surface offered by each shelf of the vending machine, said transportation means are dimensioned according to the size of the products to be dispensed.

In view of the above, the design of said transportation means must take into account the size of the products to be dispensed, with the drawback that said transportation means cannot hold products with larger size.

Likewise, said transportation means may be inappropriate if the products to be dispensed have a lower size.

The JP 2007 199852 A patent relates to a vending machine for distribution of products such as soft drinks, food and similar items. The problem this invention proposes to solve relates to the preservation of products at a correct temperature, so that they do not deteriorate inside the vending machine. Therefore, the patent discloses the system and devices used to maintain effective cooling or low heating in a correct way.

The U.S. Pat. No. 5,341,954 A patent relates to a vending machine for distribution of products such as soft drinks, food and similar items. Said machine comprises a flexible belt with transparent dividers that are regularly spaced at predetermined intervals along the belt. Said belt actuates the helical product dispenser, which consists in a sort of spiral, the turns of which contain the products to be dispensed. The purpose of the patent was to show the products to the consumer by means of a transparent panel and transparent dividers situated between the products.

The EP 1970867 A2 patent relates to a vending machine to dispense products, such as soft drinks, food and similar items. The invention teaches to arrange products vertically, separated by small separator pieces, providing for a last support body for the last product to dispense. The presence of said support body guarantees that said last product is in correct vertical position, preventing all products in the same row from falling.

The purpose of the present invention is to remedy the aforesaid drawbacks by devising a vending machine provided with an innovative dispenser that can adjust to the size of the products to be dispensed.

A further purpose of the present invention is to devise an innovative dispenser with small volume under each shelf.

An additional purpose of the present invention is to devise a new dispenser that, in addition to satisfying the aforesaid purposes, can work continuously, meaning that the transportation means can dispense the products cyclically and need not to be stopped and brought back to an initial loading position.

In other words, the transportation means of the dispenser do not have a loading position and a complete distribution position; on the contrary, said transportation means can be loaded at any time and are dispensed in a cyclical mode.

### BRIEF SUMMARY OF THE INVENTION

The vending machine of the invention comprises transportation means provided on each shelf, consisting in:
two lateral guide means;
at least two chains guided by said lateral guide means;
a series of transversal and vertical dividers laterally supported by said at least two chains.

Because of the removable connection between dividers and lateral chains, the distance between two consecutive dividers can be changed in order to exactly contain the product to be dispensed.

Said transversal dividers are situated in vertical position on the shelf whereas, as soon as they go beyond the front edge of the shelf, they take a horizontal position so that space can be saved under the shelf in order to get the multiple shelves of the vending machine as close as possible.

Thanks to a return system of said dividers, as soon as they go beyond the rear edge of the shelf, they recover a vertical position, thus allowing the transportation means to work continuously.

### BRIEF DESCRIPTION OF THE SEVERAL VIEWS OF THE DRAWINGS

With the aim of aiding a better understanding of the characteristics of the invention, the description of the vending machine according to the present invention continues with reference to the attached set of drawings with an illustrative, rather than limiting value, wherein:

FIGS. 1 and 2 are two side views of the handling system of the vending machine of the invention, in two different positions, respectively.

FIG. 3 is a sectional view of FIG. 2 along plane III-III.

FIG. 4 is an axonometric view showing a shelf vending machine of the invention with handling system in the same working position of FIG. 2;

FIG. 5 is identical to FIG. 2, except for it shows the transportation means of the handling system according to an additional embodiment;

FIG. 6 is a diagrammatic view showing the various trajectories of the chains whereon each divider is fixed.

FIG. 7 is an axonometric view showing the handling system according, to a preferred embodiment.

### DETAILED DESCRIPTION OF THE INVENTION

The vending machine of the invention comprises a support frame (not shown in the enclosed figures) and a set of horizontal shelves (P) for products (D) to be dispensed.

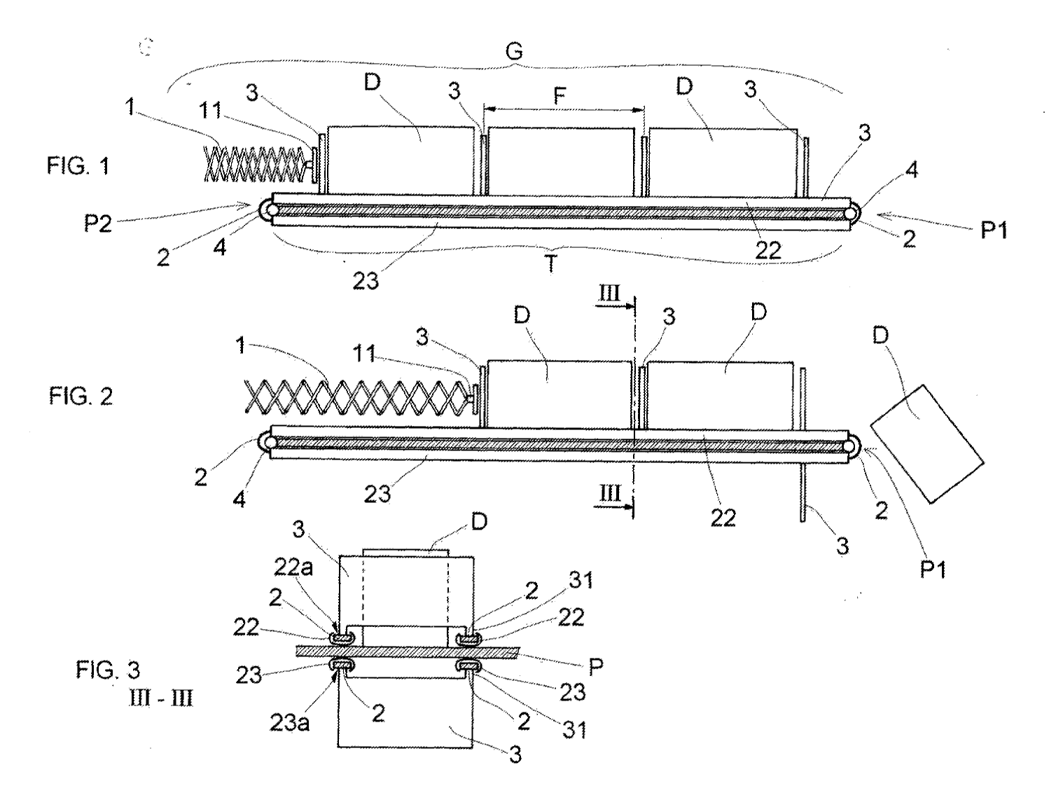

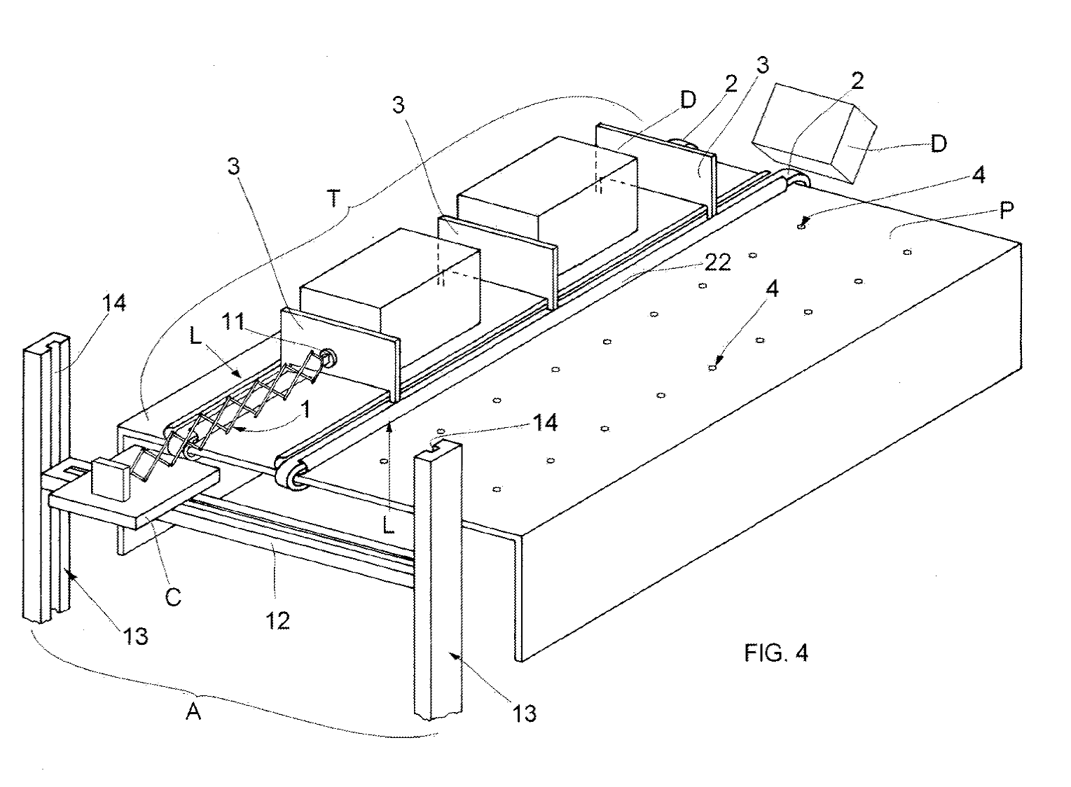

Referring now to FIGS. 1 and 4, said vending machine comprises a handling system (G) for products (D), which comprises transportation means (T) situated on the shelves (P) of the vending machine, and actuation means (A) for said transportation means (T).

Although the enclosed figures show only one line of products (D) with relevant transportation means (T), it is obvious that each shelf (P) will comprise a set of transportation means (T) one next to the other, each of them being adapted to dispense a line of products (D).

Said actuation means (A) consist in a single actuator (1) installed on a cursor (C) adapted to make travels along a horizontal axis “X” and a vertical axis “Y” in such manner to actuate the transportation means (T) of the products (D) situated on each shelf (P) of the vending machine.

In other words, through alternate travels along the axis “X” and/or “Y”, the cursor (C) is positioned in correspondence of the transportation means (T), and returns to a neutral position, after actuating said transportation means.

in view of the above, all transportation means (T) provided on the various shelves (P) of the vending machine of the invention can be actuated providing a single actuator (1) in the vending machine.

Specifically, said actuator (1) consists in a pusher (1), having a tip (11). The tip (11) slides along an axis “Z”, perpendicular to the plane where axes “X” and “Y” lie.

Said pusher (1) is fixed to the cursor (C), which slides on a crosspiece (12) in intermediate position with respect to two lateral uprights (13).

Said crosspiece (12) is connected to the uprights (13) by means of sliding devices (not shown in the enclosed figures, being of known type in the prior art) inside slides (14) obtained on said uprights (13); so, the crosspiece (12) can be positioned front time to time in correspondence with the shelf (P) with the product (D) to be dispensed.

Referring to FIGS. 1 and 4, said transportation means (T) consist in:
two guide means (L);
two chains (2) guided by said lateral guide means (L);
a series of transversal and vertical dividers (3) laterally supported by the two chains (2).

More precisely, said guide means (L) consist in two lateral slides (22,23), each of them being composed of two opposite sections, of which one (22) is fixed on the shelf (P) and one (23) is fixed under the shelf (P).

Each of said sections (22, 23) of a lateral guide means (L) has a U-shaped section and slidingly houses the chain (2), which has preferably a dosed configuration, as shown in the enclosed figures.

Referring to FIG. 3, each of said sections (22, 23) has an opening (22a, 23a) facing the opposite side with respect to the shelf (P) whereon it is fixed.

Said transversal dividers (3) are provided, with removable means (31) for connection to said chains (2), being situated inside the opening (22a, 23a) of the section (22, 23) and fixed to the links of the chains (2).

Specifically, said connection means consist in elastically deformable pins (31) adapted to be forcedly inserted in the links of the chain (2).

According to the size of the product (D) to be dispensed, which is positioned between a pair of dividers (3) of the transportation means (T), the distance (F) between a divider (3) and the following one can be changed by simply fixing the dividers (3) to the chain (2) in a different position, as shown in FIG. 1.

So, objects with different size can be positioned along the same product line, and pushed by the same transportation means (T), thus optimizing the space offered by the shelf (P).

Referring to FIG. 4, likewise, in order to enlarge or reduce the guide means (L) according to the width of the product (D) to be dispensed, the shelf (P) is provided with a series of slots (4) for insertion of center pins (not shown in the enclosed figures) provided, on said guide means (L).

Obviously, a divider (3) with suitable size must be used according to the width of the guide means (L).

Advantageously, the removable connection means (31) of dividers (3) are provided with springs, not shown in the enclosed figures, which maintain the divider (3) in perpendicular position to the shelf (P) when the divider is positioned on the shelf (P), whereas they rotate the divider (3) in parallel position to the shelf (P) as soon as the divider goes beyond the front edge (P1) of the shelf and is positioned under the shelf.

It must be noted that each shelf has a front edge (P1) beyond which the product to be dispensed is adapted to fall and a rear edge (P2).

More precisely, said springs rotate the divider (3) as soon as said removable connection means conic out of the slides (22) or in any case before entering the guides (23).

So, the space occupied by the dividers can be optimized as soon as they are disposed under the shelf (P).

As regards the operation of the transportation means provided in the vending machine of the invention, it must be noted that, in order to load them with the products to be dispensed, all dividers must be disposed on the shelf as shown in FIG. 1.

The actuation means actuate the transportation means until all products are dispensed and all dividers are positioned under the shelf (P).

Now, the transportation means are moved back, replacing all dividers on the shelf and disposing the new products to be dispensed between a divider and the following one, adjusting the distance (F) if necessary.

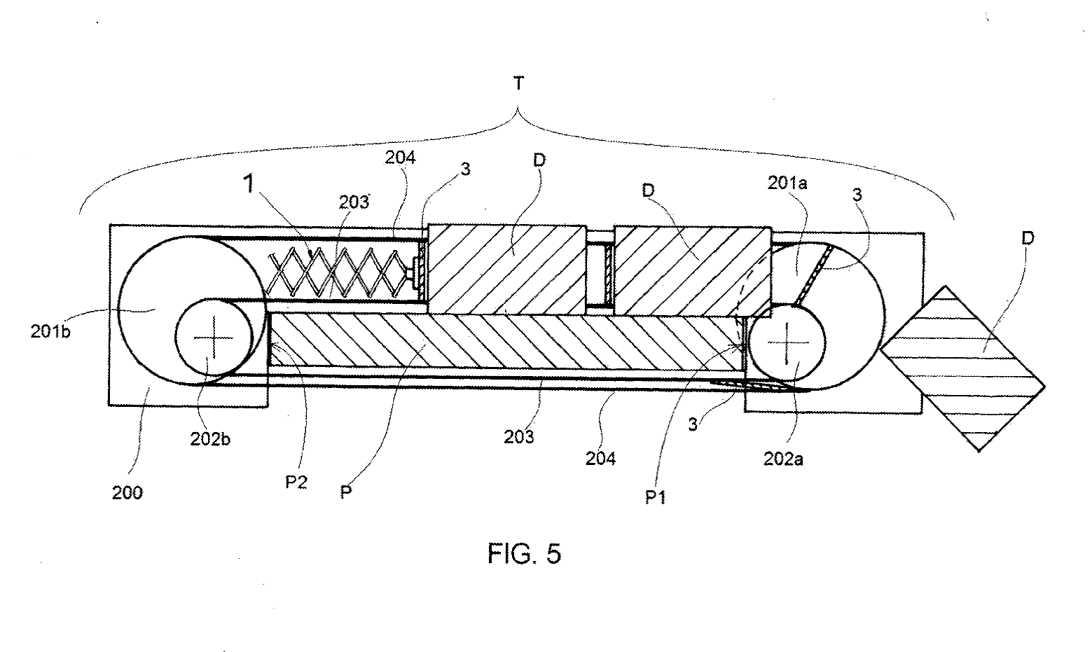

FIG. 5 shows an alternative embodiment of the transportation means (T) provided in the vending machine of the invention.

The advantages of this alternative embodiment will appear clearer from the following description.

According to this embodiment, the two lateral guide means (L) consist in two lateral edges (200), each of them comprising two pairs of toothed wheels (201a, 201b and 202a, 202b).

Each pair of toothed wheels (201a, 201b and 202a, 202b) comprises two front toothed wheels (201a,202a)—in correspondence of the front edge of the shelf (P)—and two rear toothed wheels (201b, 202b).

FIG. 5 shows a lateral edge (200) supporting two pairs of toothed wheels (201a, 201b and 202a, 202h), a pair of wheels with lower diameter (202a, 202b) and a pair of wheels with higher diameter (201a, 201b).

Said transportation means (T) comprise two chains (203, 204) for each edge (200), a first chain (203) being wound on the toothed wheels with lower diameter (202a, 202b) and a second chain (204) being wound on the toothed wheels with higher diameter (201a, 201b).

As shown, the toothed wheels (201a, 201b and 202a, 202b) revolve around horizontal parallel axes in perpendicular position to the lateral edge (200).

Moreover, as shown in FIG. 5, each divider (3) is connected to both chains (203, 204).

More precisely, each divider (3) is connected in lower position to the first chain (203), whereas it is connected in upper position to the second chain (204).

The means used to connect the divider (3) to the chain are adapted to rotate the divider (3) according to a horizontal axis in parallel position to the axes of rotation of the toothed wheels (201a, 201b and 202a, 202b).

Because of the different trajectories of the chains (203, 204) whereon the divider (3) is fixed, the divider (3) maintains a position perpendicular to the shelf (P) when it is on the shelf (P), whereas it maintains a position parallel to the shelf (P) when it is under the shelf (P).

So, the space taken by the transportation means (T) can be optimized as soon as they are disposed under the shelf (P).

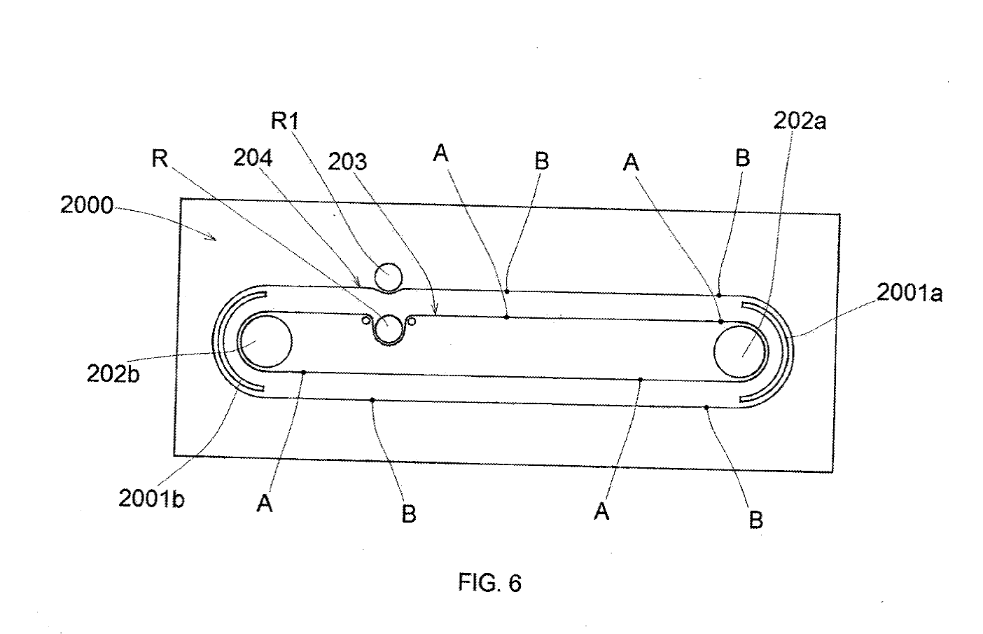

FIG. 6 is a diagrammatic view of the different trajectories of the chains (203, 204) whereon each divider (3) is fixed.

Letters A and B are used to indicate two fixing points of a divider (3), respectively to the first (203) and the second chain (204).

Still referring to FIG. 6, when the product to be dispensed must be positioned on the shelf (P), the divider (3) must be in vertical position; for this reason, the two points (A and B) are vertically aligned on the shelf (P), so that the divider (3) is in vertical position.

On the contrary, the two points (A and B) are basically aligned horizontally under the shelf (P), so that the divider (3) is in horizontal position.

By means of a sprocket wheel (R) the first chain (203) makes an additional trajectory, in addition to the one necessary to be wound around the two toothed wheels with lower diameter (202a, 202b); said additional trajectory is necessary to realign the points (A and B) vertically on the shelf (P).

It must be noted that said sprocket wheel (R) is positioned in correspondence of the rear edge of the shelf (P) in such manner that the divider (3) remains in horizontal position for the entire travel under the shelf (P) between the front edge (P1) and rear edge (P2), then being disposed in vertical position as soon as it is positioned on the shelf (P).

More precisely, said additional trajectory of the first chain (203), which is made possible because of its winding around the sprocket wheel (R), allows both chains (203 and 204) to have the same length, although the first chain (203) is wound on the toothed wheels with lower diameter (202a, 202b) and the second chain (204) is wound on the toothed wheels with higher diameter (201a, 201b).

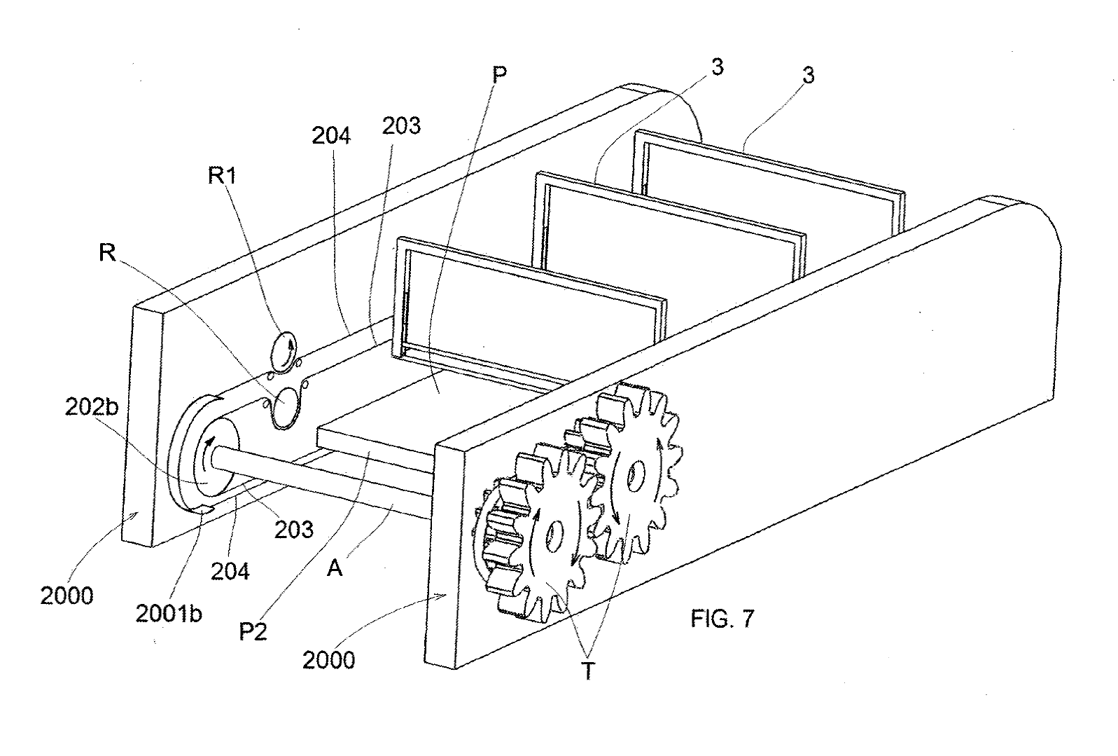

Referring to FIG. 7, according to a preferred embodiment of the invention, the rear toothed wheel with lower diameter (202b) is a drive wheel.

Still referring to FIG. 7, the second chain (204) is wound and slides around said guide means (2001a, 2001b), which consist in a pair of semicircular ribs with opposite concavities facing the shelf (P).

According to this embodiment, the two rear toothed wheels (202b) of a pair of edges (2000) of the same handling system (G) are connected by means of driving means, such as for example a shaft (A), as shown in FIG. 7.

Each edge (2000) is provided with driving means (T) to transmit the rotation of the back toothed wheel (202b) to a second sprocket wheel (R1) that actuates the second chain (204).

As shown in the figures, said driving means (T) are two pinions, the first one being fixed to the rear toothed wheel (202b) and the second one being fixed to the second sprocket wheel (R1).

The rear toothed wheel (202b), pinions (T) and second sprocket wheel (R1) must be dimensioned in such manner that both chains (203 and 204) are actuated simultaneously at the same speed to guarantee the basic condition according to which the points (A e B) are moved in perfect vertical alignment on the shelf.

Advantageously, the handling system (G) comprises a passage sensor adapted to detect the time when the divider (3) goes beyond the front edge of the shelf (P).

As soon as said sensor detects that the divider (3) goes beyond the front edge of the shelf (P)—and therefore the product to be dispensed falls into the discharge chute—the actuation means (A) are stopped.

With the aim of making the handling system (G) as safe as possible, a switch is provided on the tip (11) of the pusher (1) to detect a signal as soon as it is engaged against the divider (3) of the transportation means to be actuated.

Finally, it must be noted that said chains (2, 203, 204) can consist in belts or similar items, and said toothed wheels (201a, 201b and 202a, 202b) can consist in pulleys or equivalent devices.

Referring to said actuator (1), it may also consist in a toothed wheel or preferably a pair of toothed wheels adapted to engage with the chains (2, 203, 204) of the transportation means (T).

According to another embodiment, not shown in the enclosed figures, in order to reduce the space occupied by the dividers (3) under the shelf (P), the dividers can have a bellows-configuration and can be adapted to occupy an extended position with maximum vertical dimension on the shelf and a contracted position with minimum vertical dimension under the shelf (P).

1. A vending machine comprising:
at least one horizontal shelves for supporting of product to be dispensed; said shelf having a front edge and a rear edge;
a handling system for handling of the products, said handling system comprising transportation means situated on the shelves of the vending machine, and actuation means for actuation of said transportation means;
said transportation means comprising:
two lateral guide means;
at least two chains guided by said lateral guide means;
a set of transversal dividers laterally supported by said at least two chains; each transversal divider being perpendicular to the shelf when the divider is positioned on the shelf and rotating in a substantial horizontal position parallel to the shelf, as soon as the divider goes beyond the trout edge the shelf and the divider is positioned under the shelf.

2. A vending machine of claim 1, wherein said lateral guide means consist in two lateral slides, each slide being composed of two opposite sections comprising a first section fixed above the shelf and a second section is fixed under the shelf; each section being provided with U-shaped section and slidingly housing the chain.

3. A vending machine of claim 2, wherein
each section has an opening facing an opposite side with respect to the shelf whereon the section is fixed;
said transversal dividers are provided with removable means for connection to said chains situated inside the opening of the section and fixed to the links of the chain.

4. A vending machine of claim 3, wherein said removable connection means consist in elastically deformable pins adapted to be forcedly inserted in the links of the chain.

5. A vending machine of claim 4, wherein the removable connection means of the dividers are provided with springs that maintain the divider in perpendicular position to the shelf when the divider is positioned on the shelf and rotate the divider to a position parallel to the shelf as soon as the divider goes beyond the front edge of the shelf and is positioned under the shelf.

6. A vending of claim 1, wherein the two lateral guide means consist in two lateral edges, each edge comprising at least one pair of slides whereon a chain is wound.

7. A vending machine of claim 6, wherein each lateral edge comprises:
two pairs of toothed wheels comprising two front toothed wheels in correspondence of the front edge of the shelf and two back toothed wheels; wherein the two front toothed wheels have a diameter lower with respect to the diameter of the two rear toothed wheels;
two chains comprising a first chain wound on the front toothed wheels and a second chain wound on the rear toothed wheels; each divider being connected to both first and second chains.

8. A vending machine of claim 6, wherein each of said lateral edges comprises:
one pair of toothed wheels and one pair of semicircular ribs with opposite concavities facing the shelf (P);
two chains comprising a first chain wound on the toothed wheels with lower diameter and a second chain slides on the semicircular ribs wherein each divider is connected to both first and second chains.

9. A vending machine of claim 7, wherein said divider is connected to the first and second chains with means that allow for rotation of the divider according to a horizontal axis parallel to the axes of rotation of the toothed wheels.

10. A vending machine of claim 1, wherein the shelf is provided with a set of slots and the lateral guide means are provided with center pins adapted to be inserted into the slots of the shelf.

11. A vending machine of claim 1, wherein said actuation means consist in a single actuator installed on a cursor adapted to make travels along a horizontal axis “X” and a vertical axis “Y” in such manner to actuate the transportation means of the products situated on each shelf of the vending machine.

12. A vending machine of claim 1, wherein said actuator is a pusher.

13. A vending machine of claim 11, wherein said cursor slides above a crosspiece in intermediate position between two lateral uprights and said cursor is connected to the uprights by means of devices sliding in slides obtained on said uprights.

14. A vending machine of claim 7, wherein both chains have the same length.

15. A vending machine of claim 6, wherein each lateral edge of the two lateral guide means comprises a sprocket wheel whereon the first chain is wound in such manner that the chains have the same length.

16. A vending of claim 15, wherein said sprocket wheel is a drive wheel and the two rear toothed wheels of a pair of lateral edges of the same handling system are connected with driving means comprising a shaft.

17. A vending machine of claim 16, wherein each lateral edge comprises a second sprocket wheel and driving means adapted to transmit rotation of the rear toothed wheel to said second sprocket wheel that actuates the second chain; said rear toothed wheel, driving means and second sprocket wheel being suitably dimensioned so that both chains move simultaneously at the same speed.
